(19) United States
(12) Patent Application Publication
(10) Pub. No.: US 2025/0037225 A1
(43) Pub. Date: Jan. 30, 2025

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventors: Motoji OHMORI, Osaka (JP); Tatsumi NAGASHIMA, Osaka (JP); Minami NAKA, Tokyo (JP)

(21) Appl. No.: 18/810,751

(22) Filed: Aug. 21, 2024

Related U.S. Application Data
(63) Continuation of application No. PCT/JP2022/040531, filed on Oct. 28, 2022.

(30) Foreign Application Priority Data
Feb. 22, 2022 (JP) 2022-025919

(51) Int. Cl. G06Q 50/40; G08G 1/14

(52) U.S. Cl. CPC G06Q 50/40; G08G 1/14

(57) ABSTRACT

An information processing device performs: acquiring entry information indicating an entry of a user into an administrative region of a store and including a user ID, an entry time when the user entered, and a planned receipt time associated with the user ID for receiving a commodity; determining, when a difference between the entry time and the planned receipt time is larger than a given number, location information about a parking location which is a distance equal to or shorter than a predetermined distance away from the store as parking location information on the basis of parking information which is held in a memory and includes location information about parking locations in a parking place in the administrative region; and outputting the parking location information.

### FIELD OF INVENTION

The present disclosure relates to a technology of providing information about delivery of commodities at a store.

### BACKGROUND ART

Patent Literature 1 discloses a technology of allowing a user to receive, at a parking lot or place of a store, a commodity of the store ordered online in advance. Specifically, Patent Literature 1 discloses a technology of, upon detection of an arrival of a vehicle of a user at a parking place of a store, arranging a commodity ordered by the user in a kiosk, displaying an instruction of delivering the commodity from the kiosk to the vehicle on a display of the kiosk, and making a clerk deliver the commodity from the kiosk to the vehicle in accordance with the instruction.

However, the technology of Patent Literature 1 fails to consider a visit or non-visit of a user to a store, and thus needs further improvement to determine a parking location which is highly convenient for the user.
Patent Literature 1: US Patent Publication No. 10373226

### SUMMARY OF THE INVENTION

The present disclosure has been accomplished to solve the drawbacks described above, and has an object of providing a technology of determining a parking location which is highly convenient for a user in consideration of a visit or non-visit of the user to a store.

An information processing method according to one aspect of the present disclosure is an information processing method for providing information about a delivery of a commodity at a store. The information processing method includes: by a computer, acquiring entry information indicating an entry of a user into an administrative region of the store and including a user ID, an entry time when the user entered, and a planned receipt time associated with the user ID for receiving a commodity; determining, when a difference between the entry time and the planned receipt time is larger than a given number, location information about a parking location which is a distance equal to or shorter than a predetermined distance away from the store as parking location information on the basis of parking information which is held in a memory and includes location information about parking locations in a parking place in the administrative region; and outputting the parking location information.

This disclosure achieves determination of a parking location which is highly convenient for a user in consideration of a visit or non-visit of the user to a store.

### BRIEF DESCRIPTION OF THE DRAWINGS

FIG. 1 is a block diagram showing an example of an overall configuration of an information processing system in a first embodiment of the present disclosure.

FIG. 2 is a table showing an example of a data configuration of an ordered commodity database.

FIG. 3 is an illustration of a first example of parking information.

FIG. 4 is a flowchart showing a first example of a process by the information processing system in the first embodiment.

FIG. 5 is a flowchart showing details of step S4 in FIG. 4.

FIG. 6 is a flowchart showing a second example of the process by the information processing system in the first embodiment.

FIG. 7 is a flowchart showing an example of a process in a second embodiment.

FIG. 8 is an illustration of a display screen image of confirmation information displayed on a user terminal.

FIG. 9 is an illustration of a display screen image of change confirmation information displayed on the user terminal.

FIG. 10 is an illustration of a display screen image of receivable information displayed on a store terminal.

FIG. 11 is a flowchart showing an example of a process in a third embodiment.

FIG. 12 is a table showing an example of a data configuration of a purchase history database.

FIG. 13 is an illustration of parking information in the third embodiment of the disclosure.

FIG. 14 is an illustration of details of the parking information in the third embodiment.

FIG. 15 is an illustration of an example of parking information in a fourth embodiment.

FIG. 16 is an illustration of an example of parking information in a modification of the fourth embodiment.

### DETAILED DESCRIPTION

Knowledge forming the basis of the present disclosure

A service for delivering a commodity of a store ordered online in advance to a user in a parking place of the store has been studied. In this service, when the user parks a vehicle thereof in the parking place of the store, a clerk delivers the commodity from the store to a parking location. This allows the user to receive the commodity without entering the store.

In contrast, users having come to receive their respective commodities may include a user who will visit the store to do shopping. Determination of a parking location to be as close as possible from the store for such a user with an aim of a shorter moving distance from the parking location to the store enhances the convenience for the user.

In this regard, determination of parking locations closer to the store for all the users having come to receive their commodities may result in determining a parking location closer to the store even for a user who desires only receipt of an associated commodity. This would lead to a failure in determination of a parking location closer to the store for a user having a will to do shopping and accordingly lower the convenience for the user. To avoid the situation, it is necessary to distinguish a user who only desires to receive a commodity from another user who has a will to do shopping in addition to receipt of a commodity.

Under the circumstances, the present inventors have obtained the knowledge that a user who has a will to do shopping in addition to receipt of a commodity enters an administrative region of a store a predetermined period before a planned receipt time for the commodity, and the present inventors have conceived of the features to be described below.

(1) An information processing method according to one aspect of the present disclosure is an information processing method for providing information about delivery of commodities at a store. The information processing method includes: by a computer, acquiring entry information indicating an entry of a user into an administrative region of the store and including a user ID, an entry time when the user entered, and a planned receipt time associated with the user ID for receiving a commodity; determining, when a difference between the entry time and the planned receipt time is larger than a given number, location information about a parking location which is a distance equal to or shorter than a predetermined distance away from the store as parking location information on the basis of parking information which is held in a memory and includes location information about parking locations in a parking place in the administrative region; and outputting the parking location information.

In this configuration, when a difference between an entry time and a planned receipt time is larger than a given number, location information about a parking location which is a distance equal to or shorter than a predetermined distance away from a store is determined as parking location information. The configuration thus enables determination of a parking location which is highly convenient for the user in consideration of a visit or non-visit of the user to the store.

(2) In the information processing method according to (1) above, in the determining, when the difference is smaller than the given number, location information about a predetermined parking location may be determined as the parking location information on the basis of the parking information.

In this configuration, when the difference is smaller than the given number, location information about the predetermined parking location is determined as the parking location information. This configuration hence succeeds in avoiding a situation in which a user who has a will to visit the store fails to park at a parking location near the store due to determination of the parking location near the store as a parking location for another user who has no desire to do shopping.

(3) In the information processing method according to (1) or (2) above, the parking location information which is determined when the difference is larger than the given number may indicate a parking location which is a distance equal to or shorter than the predetermined distance away from a doorway of the store.

This configuration enables determination of a parking location for a shorter moving distance from the parking location to the store in consideration of the doorway of the store.

(4) In the information processing method according to any one of (1) to (3) above, in the outputting, confirmation information for confirming a visit or non-visit to the store may be output when the difference is larger than the given number, and the location information about the parking location which is the distance equal to or shorter than the predetermined distance away from the store may be output as the parking location information on receipt of information indicating the visit to the store.

This configuration enables determination of a parking location which is highly convenient for a user after accurately specifying whether the user has a will to visit the store.

(5) In the information processing method according to any one of (1) to (3) above, in the outputting, confirmation information for confirming a visit or non-visit to the store may be output when the difference is larger than the given number, and change confirmation information for confirming a request or non-request for a change of the planned receipt time may be output on receipt of information indicating the non-visit to the store.

This configuration enables determination of a parking location which is suitable for a user after accurately specifying whether the user has a will to visit the store even when the difference is larger than the given number.

(6) In the information processing method according to (5) above, in the outputting, receivable information indicating that the commodity is receivable may be output on receipt of change request information indicating the request for the change of the planned receipt time.

This configuration permits a user who has a request for a change of the planned receipt time to receive a commodity at a time reflecting the change. This succeeds in an earlier delivery time for the commodity by, for example, using the difference in time period.

(7) In the information processing method according to (1) above, in the acquiring, purchase history information concerning past purchase by the user including at least a purchase date and time and a purchased commodity may be acquired. In the determining, a selling section which the user is highly likely to visit in the store may be estimated on the basis of the purchase history information, and location information about a parking location which is a distance equal to or shorter than the predetermined distance away from the estimated selling section may be determined as the parking location information.

In this configuration, a parking location near a selling section which the user is highly likely to visit in the administrative region is determined, and thus, the configuration attains higher convenience for the user.

(8) In the information processing method according to (7) above, the selling section may be at an arrangement location of the commodity in the store or a location of another store which is in the administrative region.

In this configuration, a parking location near an arrangement location of the commodity that the user is highly likely to visit in the store or near a store which the user is highly likely to visit in the administrative region is determined. The configuration thus enables determination of a parking location which is highly convenient for the user.

(9) In the information processing method according to any one of (1) to (8) above, the parking location information may be output to a user terminal carried by the user and a store terminal carried by a clerk of the store.

This configuration provides the user and the clerk with the parking location information, and thus allows the user to park the vehicle at the designated parking location and allows the clerk to deliver the ordered commodity to the parking location.

(10) In the information processing method according to any one of (1) to (9) above, the memory may hold a user database associating the user ID and a vehicle number with each other. In the acquiring, a vehicle image may be acquired by photographing a vehicle in the entry into the administrative region by the camera, the vehicle number may be specified from the vehicle image, and the entry information may be determined to be acquired when the user ID associated with the specified vehicle number is specified from the user database.

This configuration enables automatic detection of the entry of the vehicle of the user into the administrative region of the store.

(11) An information processing device in another aspect of the disclosure is an information processing device that provides information about delivery of commodities at a store. The information processing device includes: an acquisition part that acquires entry information indicating an entry of a user into an administrative region of the store and including a user ID, an entry time when the user entered, and a planned receipt time associated with the user ID for receiving a commodity; a determination part that determines, when a difference between the entry time and the planned receipt time is larger than a given number, location information about a parking location which is a distance equal to or shorter than a predetermined distance away from the store as parking location information on the basis of parking information which is held in a memory and includes location information about parking locations in a parking place in the administrative region; and an output part that outputting the parking location information.

This configuration makes it possible to provide a device that determines a parking location which is highly convenient for a user in consideration of a visit or non-visit of the user to the store.

(12) An information processing program in another aspect of the present disclosure is an information processing program for providing information about delivery of commodities at a store. The program includes causing a computer to execute: acquiring entry information indicating an entry of a user into an administrative region of the store and including a user ID, an entry time when the user entered, and a planned receipt time associated with the user ID for receiving a commodity; determining, when a difference between the entry time and the planned receipt time is larger than a given number, location information about a parking location which is a distance equal to or shorter than a predetermined distance away from the store as parking location information on the basis of parking information which is held in a memory and includes location information about parking locations in a parking place in the administrative region; and outputting the parking location information.

This configuration makes it possible to provide an information processing program for determining a parking location which is highly convenient for a user in consideration of a visit or non-visit of the user to the store.

This disclosure can be realized as an information processing system caused to operate by the information processing program as well. Additionally, it goes without saying that the computer program is distributable as a non-transitory computer readable storage medium like a CD-ROM, or distributable via a communication network like the Internet.

Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### First Embodiment

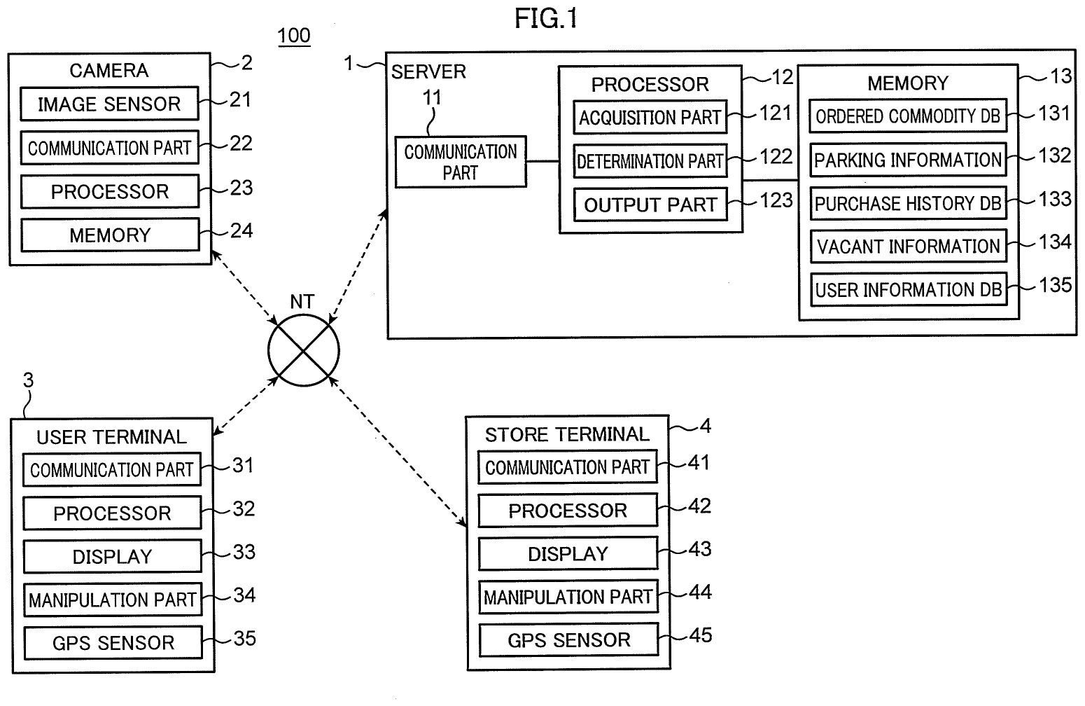

FIG. 1 is a block diagram showing an example of an overall configuration of an information processing system 100 in a first embodiment of the present disclosure. The information processing system 100 includes a server 1, a camera 2, a user terminal 3, and a store terminal 4. The server 1, the camera 2, the user terminal 3, and the store terminal 4 are communicably connected to one another via a network NT. The network NT includes, for example, a wide area network having the internet and a mobile phone communication network.

The server 1 includes, for example, a cloud server including a computer.

The camera 2 is arranged, for example, around a doorway to an administrative region of a store. Specifically, the camera 2 is arranged at a position suitable for photographing a vehicle which enters a parking place in the administrative region through the doorway. The camera 2 photographs the doorway in a predetermined frame cycle, and sends acquired image information to the server 1 in a predetermined frame cycle.

The store means a store where a user having purchased a commodity online receives the commodity. The administrative region of the store includes a building of the store and a parking place adjacent to the building. A plurality of commodities is arrayed in the building of the store. The building of the store further includes a repository that stores commodities.

The user terminal 3 is, for example, a mobile information terminal or personal digital assistant carried by the user. The mobile information terminal includes, for example, a smartphone or a tablet computer. The user terminal 3 may be formed of an in-vehicle terminal provided in the vehicle (not shown) which the user drives. The in-vehicle terminal is, for example, a car navigation system.

The store terminal 4 is, for example, a mobile information terminal carried by a clerk of the store.

Next, the configuration of the server 1 will be described in detail.

The server 1 includes a communication part 11, a processor 12, and a memory 13. The communication part 11 includes, for example, a communication circuit connecting the server 1 to the network NT. The communication part 11 receives image information from the camera 2. The communication part 11 sends, to the user terminal 3 and the store terminal 4, output information including parking location information indicating a parking location for the vehicle.

The processor 12 includes, for example, a CPU. The processor 12 has an acquisition part 121, a determination part 122, and an output part 123. Each of the acquisition part 121 to the output part 123 comes into effect when the CPU executes an information processing program. Each of the acquisition part 121 to the output part 123 may be formed of a dedicated electric circuit, such as an ASIC.

The acquisition part 121 acquires entry information indicating an entry of a user into an administrative region of a store and including a user ID, an entry time when the user entered, and a planned receipt time associated with the user ID included in the entry information for receiving an ordered commodity.

For instance, the acquisition part 121 may acquire, as the entry time, a time at which the entry information is generated. For instance, the acquisition part 121 may acquire a planned receipt time for receiving an ordered commodity with reference to an ordered commodity database 131.

For instance, the acquisition part 121 specifies, as vehicle image information, image information indicating the vehicle in the entry into the administrative region of the store among information sent from the camera 2. In a success of detection of a vehicle number from the specified vehicle image information and specifying of the user ID associated with the detected vehicle number from the ordered commodity database 131, the acquisition part 121 may acquire the entry information by generating entry information including the specified user ID.

For instance, the acquisition part 121 determines whether the image information indicates a vehicle which enters the administrative region by applying image recognition processing to the image information sent from the camera 2. The acquisition part 121 may specify the image information as the vehicle image information when the image information is determined to indicate the vehicle. Adoptable examples of the image recognition processing include processing using a classifier to detect a vehicle and an advancing direction of the vehicle from the image information. The acquisition part 121 acquires a vehicle label and an advancing direction label of the vehicle by inputting the image information into the classifier. The acquisition part 121 may specify the image information as the vehicle image information when the vehicle label is acquired and the advancing direction label indicates a direction in which the vehicle enters the administrative region. The classifier is prepared in advance through machine learning of vehicle image information given a bounding box showing the vehicle and an advancing direction of the vehicle.

The acquisition part 121 may extract a domain showing a vehicle registration plate from a vehicle image indicated by the vehicle image information, and detect a vehicle number by applying character recognition processing to the domain. Specifically, in the disclosure, the vehicle number includes, for example, a character string given on the vehicle registration plate.

The acquisition part 121 may acquire the entry information by another way in place of the way using the image information. For instance, the acquisition part 121 may acquire, as entry information, information sent from the user terminal 3 and including a user ID when a vehicle enters an administrative region of a store. In this case, the user terminal 3 may send the entry information to the server 1 on receipt of an input instruction of telling the entry from the user in the entry of the vehicle into the administrative region. Alternatively, the user terminal 3 may send entry information when detecting the entry of the vehicle into the administrative region of the store on the basis of location information about the terminal and location information about the store.

The determination part 122 determines, when a difference between the entry time and the planned receipt time is larger than a given number, location information about a parking location which is a distance equal to or shorter than a predetermined distance away from the store as parking location information on the basis of parking information 132 which is held in a memory 13. This allows a user having a will to do shopping to park a vehicle at a parking location near the store and thus enhances the convenience. The parking information 132 includes location information about parking locations in the parking place in the administrative region, and will be described in detail later.

By contrast, when the difference is smaller than the given number, the determination part 122 determines location information about a predetermined parking location as the parking location information on the basis of the parking information. This makes another user having no will to do shopping park a vehicle at the predetermined parking location, and thus ensures the parking location near the store for the user having the will to do shopping.

Here, the parking location information which is determined when the difference is larger than the given number indicates a parking location which is a distance equal to or shorter than the predetermined distance away from a doorway of the store. The predetermined distance may take an appropriate value, such as 5 m, 10 m, and 15 m. Adoptable examples of the given number include a predefined time period with which a user is considered to have a will to do shopping, and adoptable examples of an appropriate value for the period include thirty minutes, one hour, two hours, and other period.

The output part 123 outputs output information including the parking location information determined by the determination part 122. The output part 123 may output the output information to, for example, the user terminal 3 and the store terminal 4. The output part 123 may output the output information by using the communication part 11.

The memory 13 includes a non-volatile storage device. The memory 13 stores the ordered commodity database 131, the parking information 132, a purchase history database 133, vacant information 134, and a user information database 135.

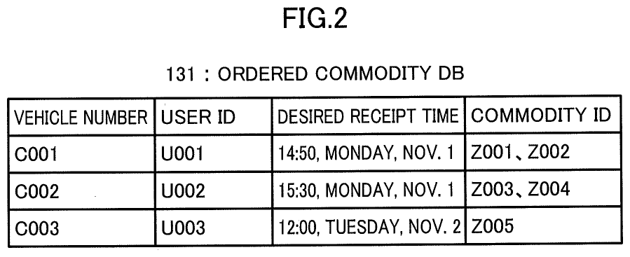

FIG. 2 is a table showing an example of a data configuration of the ordered commodity database 131. The ordered commodity database 131 includes a vehicle number field, a user ID field, a desired receipt time field, and a commodity ID field, and stores relevant information in the fields in association with one another. In the ordered commodity database 131, one record is associated with one order. The information indicating the one order represents ordered commodity information.

A vehicle number is an identifier of a vehicle owned by a user having ordered a commodity. The vehicle number includes, for example, a character string given on the vehicle registration plate. Here, the vehicle number is simply expressed by using a symbol string, such as “C001”, for convenience of explanation.

A user ID is an identifier of the user having ordered the commodity. The user ID may include, for example, a name or a symbol string registered in advance.

A desired receipt time indicates a time at which a user desires to receive a commodity at a store. The desired receipt time is input by the user at the time of ordering the commodity. In the order associated with the record in the first row, the desired receipt time indicates 14:50 on Monday on November 1^{st}.

A commodity ID is an identifier of the commodity ordered by the user. The order associated with the record in the first row shows two commodities ordered by the user. The record hence has registration of commodity IDs “Z001” and “Z002” of these commodities.

Such an order as registered in the ordered commodity database 131 is made online by a user on the Internet. The user uses a user terminal 3 thereof to make an access to an order site of a store, and conducts a manipulation of ordering a desired commodity and a manipulation of inputting a desired receipt time. In this manner, order information associating the user ID, the desired receipt time, and the commodity ID with one another is sent to the server 1. The server 1 having received the order information creates a new record in the ordered commodity database 131, and registers, in the new record, the user ID, the desired receipt time, and the commodity ID included in the order information. It is noted here that the user inputs the vehicle number in advance at initial registration on the online site, and the server 1 causes the memory 13 to store the user information database 135 associating the user ID and the vehicle number with each other. Hence, the server 1 may specify the vehicle number associated with the user ID included in the order information with reference to the user information database 135 and record the specified vehicle number in a vehicle number field of the newly created record.

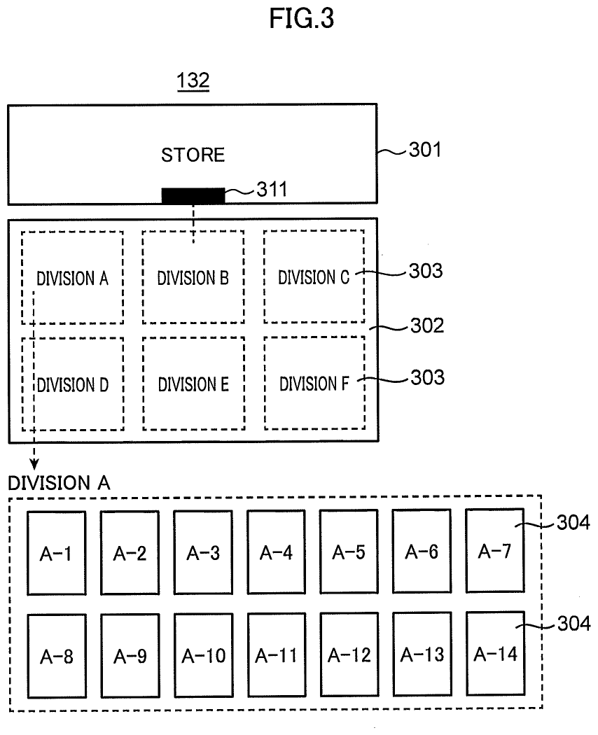

FIG. 3 is an illustration of a first example of the parking information 132. The parking information 132 is information obtained by mapping a location of a store 301 and a location of a parking place 302 on, for example, a two-dimensional coordinate space defined by an X-axis and a Y-axis. The parking information 132 defines a coordinate of respective locations of the store 301, a doorway 311, and the parking place 302.

The parking place 302 includes a plurality of divisions 303. In this example, the parking place 302 includes six divisions 303 from a division A to a division F. Each of the divisions 303 has a plurality of parking spaces 304. Each of the parking spaces 304 is a space for parking one vehicle. In this example, the division A has fourteen parking spaces 304 from A-1 to A-14. The parking information 132 shows respective mapped locations of the divisions 303 and the parking spaces 304. The parking place 302 may include a multi-story parking garage or multi-story car park. In this case, the parking information 132 is formed of a three-dimensional space defined by an X-axis, a Y-axis, and additionally a Z-axis denoting a floor of the parking garage.

For instance, a label indicating a division associated with each of the divisions 303 from the division A to the division F is usable as the parking location information. Here, each division 303 in the actual parking place 302 is displayed with an associated label indicating the division. Therefore, a user and a clerk having checked the parking location information can easily confirm where a parking location for a vehicle actually is.

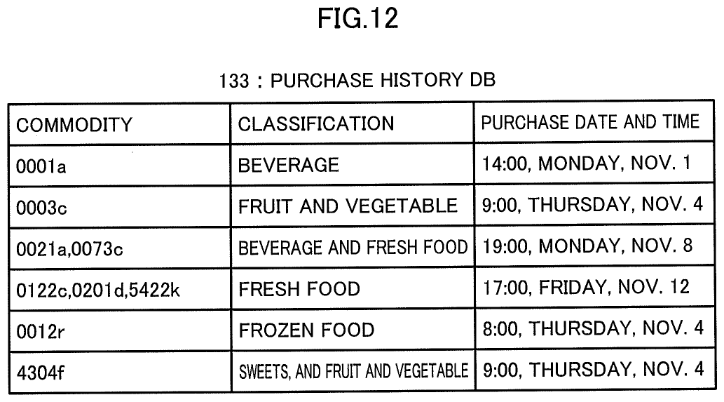

Referring back to FIG. 1, the purchase history database 133 is a database showing a history of commodities purchased by each user at the store 301. Details of the purchase history database 133 will be described later with reference to FIG. 12.

The vacant information 134 indicates a vacant space being a parking space 304 which is vacant without being occupied by a vehicle in a parking place. For instance, the vacant information 134 has registration of information about an occupancy by a parked vehicle or a vacancy for each parking space 304 in the parking place. The server 1 may detect a vacant space on the basis of sensing data sent from a parking sensor arranged in each parking space 304 to detect an occupancy by a parked vehicle or a vacancy, and update the vacant information 134 on the basis of a result of the detection. The parking sensor may include, for example, an object sensor, and may send sensing data indicating an occupancy by a parked vehicle to the server 1 on detection of the parked vehicle and send sensing data indicating a vacancy to the server 1 on detection of the vacancy. The server 1 may detect the occupancy by the parked vehicle or the vacancy by applying image processing to image information indicating a parking place photographed by a camera provided in the parking place. The image information indicating the parking place shows an image in a bird's-eye view of the entire parking place. The server 1 may extract each parking space 304 and a vehicle occupying an associated parking space 304 from the image information indicating the parking place to detect a certain parking space 304 which is vacant without being occupied by a vehicle and define the certain parking space 304 as a vacant space.

The user information database 135 is a database for registration of user information about a plurality of users having registered as users on the online site of the store 301. The user information is stored in association with a name, an address, contact information, a user ID, a vehicle number, and attribute information. Examples of the attribute information include a gender, an age, a family configuration, and an occupation. The user information is registered in the user information database 135, for example, when the user performs the user registration.

Heretofore, the configuration of the server 1 is described. Subsequently, the camera 2 will be described. The camera 2 includes an image sensor 21, a communication part 22, a processor 23, and a memory 24. Examples of the image sensor 21 include an imaging element, such as an CMOS image sensor. The communication part 22 includes a communication circuit connecting the camera 2 to the network NT. The processor 23 includes, for example, a CPU, and controls the camera 2. The processor 23 causes the image sensor 21 to capture an image of a doorway to the administrative region of the store 301 in a predetermined frame cycle. The processor 23 sends image information about the image captured by the image sensor 21 in the predetermined frame cycle to the server 1 by using the communication part 22. The memory 24 includes a RAM and a ROM, and is used as a working memory of the processor 23.

In the disclosure, the camera 2 may execute the specifying of vehicle image information from the image information. In this case, the processor 23 may specify the vehicle image information from the image information by using the aforementioned classifier and send the vehicle image information to the server 1 by using the communication part 22. The server 1 having received the vehicle image information may execute the above-described detection of a vehicle number from the vehicle image information.

Next, the user terminal 3 will be described. The user terminal 3 includes a communication part 31, a processor 32, a display 33, a manipulation part 34, and a GPS sensor 35. The communication part 31 includes a communication circuit connecting the user terminal 3 to the network NT. The processor 32 includes, for example, a CPU, and controls the user terminal 3. The display 33 includes, for example, a liquid crystal panel and displays various images. The manipulation part 34 includes, for example, a touch screen and a physical button to receive a manipulation from a user. The GPS sensor 35 detects a location of the user terminal 3.

Next, the store terminal 4 will be described. The store terminal 4 includes a communication part 41, a processor 42, a display 43, a manipulation part 44, and a GPS sensor 45. The communication part 41 includes a communication circuit connecting the store terminal 4 to the network NT. The processor 42 includes, for example, a CPU, and controls the store terminal 4. The display 43 includes, for example, a liquid crystal panel and displays various images. The manipulation part 44 includes, for example, a touch screen and a physical button to receive a manipulation from a clerk. The GPS sensor 45 detects a location of the store terminal 4.

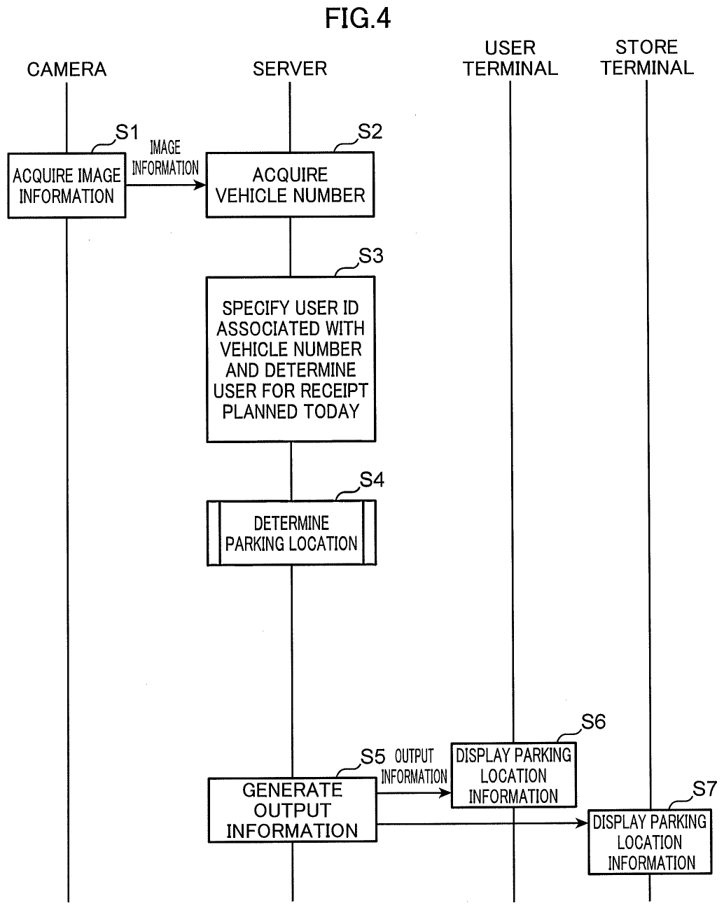

Hereinafter, a process by the information processing system 100 will be described. FIG. 4 is a flowchart showing a first example of the process by the information processing system 100 in the first embodiment. The server 1 serves as a subject of the process in the flowchart in the first example.

### Step S1

The camera 2 acquires image information by photographing a doorway to an administrative region of a store and sends the acquired image information to the server 1.

### Step S2

The acquisition part 121 of the server 1 acquires a vehicle number by applying the aforementioned image processing to the sent image information.

### Step S3

The acquisition part 121 of the server 1 specifies a user ID associated with the vehicle number with reference to the ordered commodity database 131 and determines whether a user having the specified user ID is identical to a user who plans receipt today. In detail, the acquisition part 121 retrieves, from the ordered commodity database 131, ordered commodity information associated with the vehicle number from a current time to a time after a predetermined period therefrom (e.g., one hour, three hours, and other period), the ordered commodity information designating “today” as a desired receipt time. In a success of retrieval of the ordered commodity information satisfying this condition, the acquisition part 121 determines the user indicated by the user ID associated with the vehicle number in the ordered commodity database 131 as the user who desires receipt today, and specifies the user ID associated with the vehicle number. At this time, the acquisition part 121 generates entry information including the user ID. By contrast, in a failure of retrieval of the ordered commodity information satisfying the condition from the ordered commodity database 131, no entry information is generated.

In the example in FIG. 2, the vehicle having the vehicle number “C001” enters the administrative region of the store 301 at 14:00 on November 1^{st}. In this regard, the ordered commodity database 131 has registration of ordered commodity information indicating the desired receipt time “14:50 on Monday on November 1^{st}” falling within one hour (predetermined period) from 14:00 for the vehicle number “C001”. The acquisition part 121 thus specifies the user ID “U001” associated with the vehicle number “C001”. The acquisition part 121 avoids generating entry information when failing to specify a user ID associated with a vehicle number from the ordered commodity database 131.

### Step S4

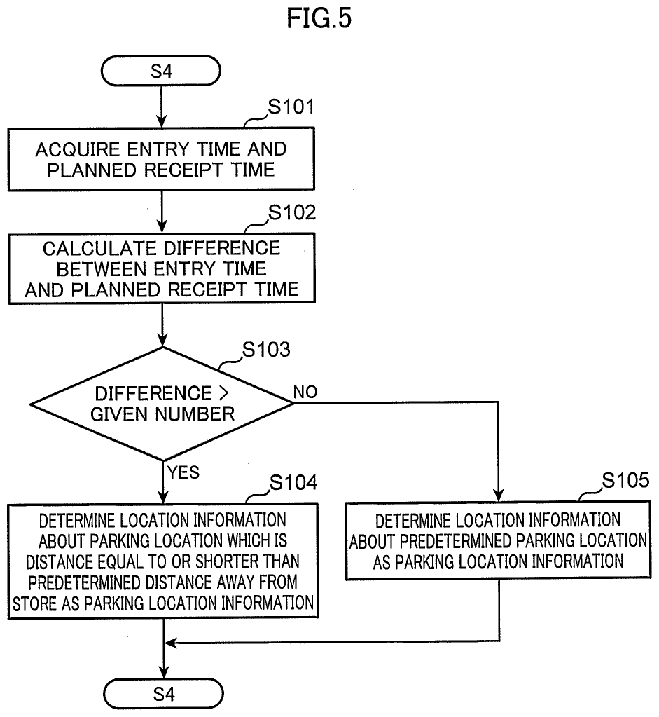

The determination part 122 of the server 1 determines a parking location. Details of the determination will be described later with reference to FIG. 5.

### Step S5

The output part 123 of the server 1 generates output information including the determined parking location and outputs the output information to the user terminal 3 and the store terminal 4.

### Step S6

The user terminal 3 displays the parking location information included in the output information on the display 33.

### Step S7

The store terminal 4 displays the parking location information included in the output information on the display 33.

FIG. 5 is a flowchart showing details of step S4 in FIG. 4.

### Step S101

The determination part 122 acquires an entry time and a planned receipt time. The entry time represents an entry time when a user entered the administrative region of the store 301 by a vehicle. The planned receipt time represents a planned receipt time for an ordered commodity planned to be received by the user today, and is acquired from the ordered commodity database 131. In the example in FIG. 2, when the user having the user ID “U001” enters the administrative region of the store 301, the date and time “14:50 on November 1^{st}” registered in a desired receipt time section is acquired as the desired receipt time.

### Step S102

The determination part 122 calculates a difference between the entry time and the planned receipt time acquired in step S101. For instance, when the entry time indicates 14:00 and the planned receipt time indicates 14:50, the difference results in fifty minutes.

### Step S103

The determination part 122 determines whether the difference calculated in step S102 is larger than a given number. The process proceeds to step S104 when the difference is larger than the given number (YES in step S103), and the process proceeds to step S105 when the difference is equal to or smaller than the given number (NO in step S103). For instance, when the given number is defined as one hour and the difference indicates fifty minutes, it is determined to be “NO” in step S103.

### Step S104

The determination part 122 specifies a parking location which is a distance equal to or shorter than a predetermined distance away from the doorway 311 of the store 301 with reference to the parking information 132, and determines location information about the specified parking location as parking location information. In the example in FIG. 3, the predetermined distance has a value which is a little smaller than a value of a secondary shortest distance from the doorway 311 to a certain division 303. Under the condition, the division B at a shortest distance from the doorway 311 is determined as a parking location.

A parking location which is a distance equal to or shorter than a predetermined distance away from the doorway 311 may be defined in advance. For instance, in FIG. 3, each of the division A, the division B, and the division C is defined in advance as a parking location which is a distance equal to or shorter than the predetermined distance away from the doorway 311. In a case where each of the division D, the division E, and the division F is defined in advance as a parking location which is a distance exceeding the predetermined distance away from the doorway 311, each of the division A, the division B, and the division C is determined as a parking location which is distance equal to or shorter than the predetermined distance away from the doorway 311.

The determination part 122 may determine a parking location on the basis of a unit of a parking space 304. In this case, the determination part 122 may specify vacant spaces from a predefined division 303 (e.g., the division B or the division A to the division C) which is a distance equal to or shorter than the predetermined distance away from the doorway 311 with reference to the vacant information 134, and determine, as a parking location, a vacant space which is at the shortest distance from the doorway 311 among the specified vacant spaces.

When the parking location is determined on the basis of a unit of a parking space 304, the parking location information includes a label indicating the parking space 304. Further, an actual parking space 304 is displayed with a label of the parking space 304. Such displaying allows the user having checked the parking location information to easily confirm a specific parking space 304 for parking a vehicle.

### Step S105

The determination part 122 determines location information about a predetermined parking location as parking location information with reference to the parking information 132. In the example in FIG. 2, the division F is defined in advance as a predetermined parking location. Thus, the division F is determined as the predetermined parking location. However, this is just an example, and one or more divisions 303 among the divisions (e.g., the division D to the division F) each being a distance exceeding the predetermined distance away from the doorway 311 may be defined as a predetermined parking location or predetermined parking locations. Further, a vacant space which is determined at random from the vacant spaces in the division F may be determined as a parking location.

Alternatively, the determination part 122 may determine, as a parking location, a parking space 304 at random from divisions (e.g., the division D to the division F) each being a distance exceeding the predetermined distance away from the doorway 311 or from all the divisions 303. In this case, the determination part 122 may specify vacant spaces with reference to the vacant information 134, and determine a parking space 304 determined at random among the specified vacant spaces as a parking location.

Hereinafter, specific examples will be described. For example, the user having the user ID “U001” enters at 14:00 on Monday on November 1^{st}, a desired receipt time of the user indicates 15:00, and the given number indicates thirty minutes. In this example, the difference results in one hour that is larger than the given number. It is thus determined to be “YES” in step S103 and a parking location (e.g., the division B) which is a distance equal to or shorter than the predetermined distance away from the store 301 is determined as a parking location for the user.

For example, the user having the user ID “U002” enters at 17:00 on Monday on November 1^{st}, a desired receipt time of the user indicates 17:10, and the given number indicates thirty minutes. In this example, the difference results in ten minutes that are equal to or smaller than the given number. It is thus determined to be “NO” in step S103 and a predetermined parking location (e.g., the division F) is determined as a parking location for the user.

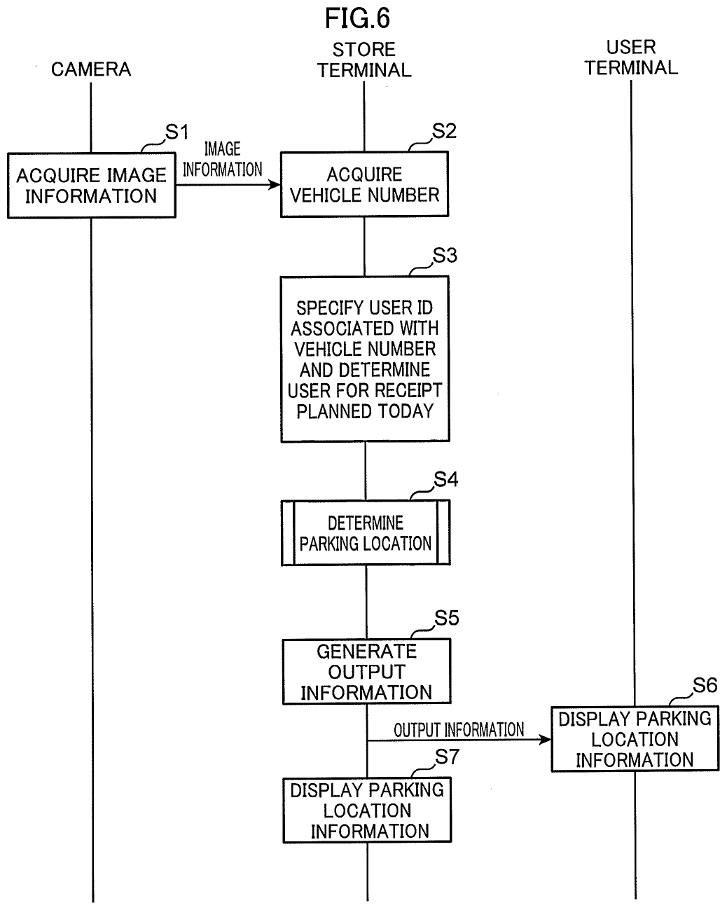

FIG. 6 is a flowchart showing a second example of the process by the information processing system 100 in the first embodiment. The store terminal 4 serves as a subject of the process in the flowchart in the second example in place of the server 1 which is omitted. In the flowchart shown in FIG. 6, steps which are the same as the steps in FIG. 4 are given the same reference numerals and signs. It is noted here that image information is sent from the camera 2 to the store terminal 4 in step S1, and the store terminal 4 executes steps S2 to S5, and S7.

Conclusively, in the first embodiment, when a difference between an entry time and a planned receipt time is larger than a given number, location information about a parking location which is a distance equal to or shorter than a predetermined distance away from a store is determined as parking location information, and thus, the first embodiment enables determination of a parking location which is highly convenient for a user in consideration of a visit or non-visit of the user to the store 301.

### Second Embodiment

A second embodiment is aimed at confirming a visit or non-visit to a store with a user when a difference between an entry time and a planned receipt time is larger than a given number. In the second embodiment, constituent elements which are the same as those in the first embodiment are given the same reference numerals and signs, and thus, description therefor will be omitted. Further, an overall configuration will be described with reference to FIG. 1 in the second embodiment.

Referring to FIG. 1, an output part 123 outputs, to a user terminal 3 via a communication part 11, confirmation information for confirming a visit or non-visit to a store 301 with a user when a difference between an entry time and a planned receipt time is larger than a given number. The output part 123 outputs, as parking location information, location information about a parking location which is a distance equal to or shorter than a predetermined distance away from the store 301 to the user terminal 3 and a store terminal 4 on receipt of information indicating the visit to the store 301 from the user terminal 3.

The output part 123 outputs, to the user terminal 3 via the communication part 11, change confirmation information for confirming a request or non-request for a change of the planned receipt time with the user on receipt of information indicating the non-visit to the store 301 from the user terminal 3 as a result of outputting the confirmation information to the user terminal 3.

The output part 123 outputs receivable information indicating that the ordered commodity is receivable to the store terminal 4 via the communication part 11 on receipt of change request information indicating the request for the change from the user terminal 3.

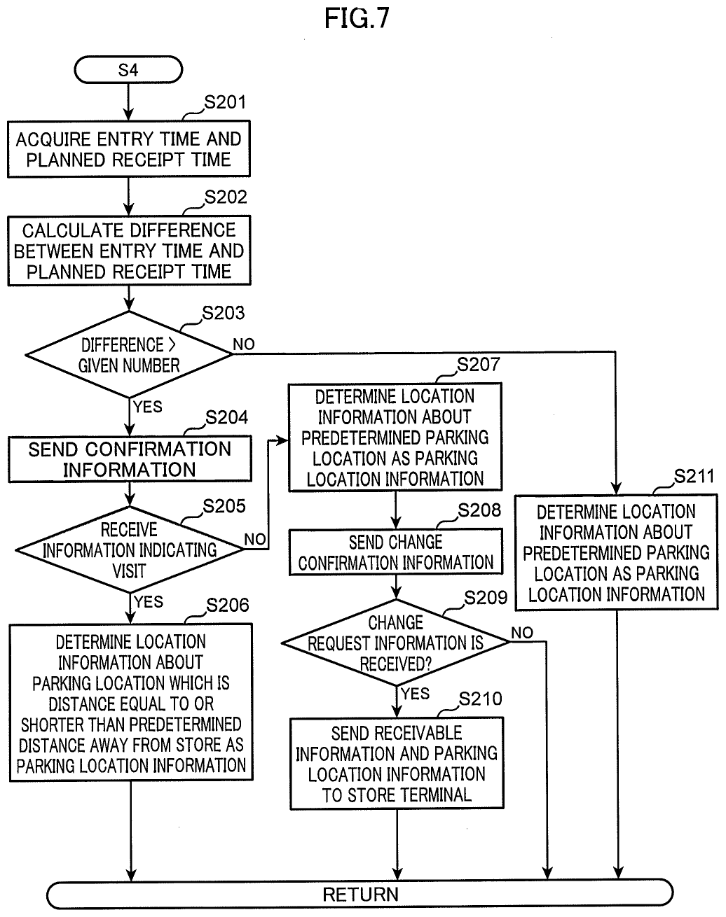

FIG. 7 is a flowchart showing an example of a process in the second embodiment. The second embodiment uses the main flowchart shown in FIG. 4 or FIG. 6. The flowchart in FIG. 7 shows details of step S4 in FIG. 4. Although the flowchart in FIG. 7 is adapted to step S4 in FIG. 4 here, the flowchart may be adapted to step S4 in FIG. 6.

Step S201 to step S203 are the same as steps S101 to S103 in FIG. 5, and thus, description therefor will be omitted.

### Step S204

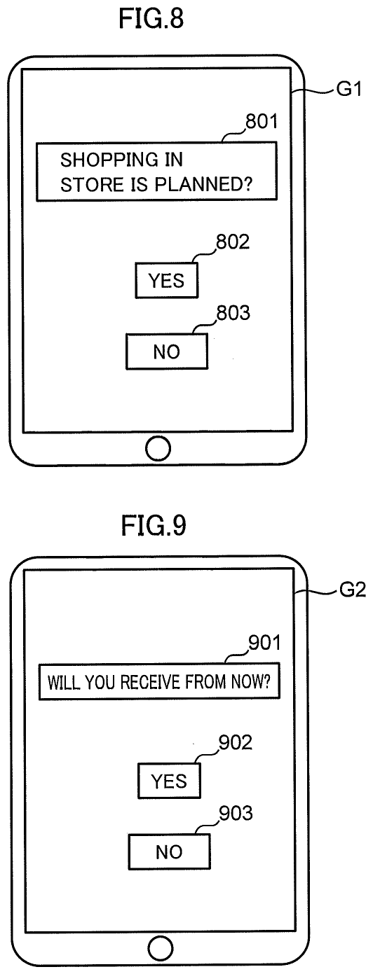

Step S204 is executed in the case of “YES” in step S203. The output part 123 sends, to the user terminal 3, confirmation information for confirming a visit or non-visit to the store 301 with the user. FIG. 8 is an illustration of a display screen image G1 of the confirmation information displayed on the user terminal 3. The display screen image G1 includes a message section 801, a “YES” button 802, and a “NO” button 803. The message section 801 shows a message for an inquiry about whether shopping in the store 301 is planned. The “YES” button 802 is touched by the user when the user plans to do shopping. The user terminal 3 sends, to the server 1, information indicating a visit to the store 301 in response to the touching of the “YES” button 802.

The “NO” button 803 is touched by the user when the user does not plan to do shopping. The user terminal 3 sends, to the server 1, information indicating a non-visit to the store 301 in response to the touching of the “NO” button 803.

### Step S205

The output part 123 leads the process to step S206 on receipt of the information indicating the visit to the store 301 (YES in step S205) and leads the process to step S207 on receipt of the information indicating the non-visit to the store 301 (NO in step S205).

The user may touch neither the “YES” button 802 nor the “NO” button 803. In this regard, the output part 123 may determine “NO” in step S205 when receiving neither the information indicating the visit to the store 301 nor the information indicating the non-visit to the store 301 until a lapse of a predetermined time period.

### Step S206

This step is the same as step S104 (FIG. 5). After a finish of step S206, the process proceeds to step S5 (FIG. 4).

### Step S207

This step is the same as step S105 (FIG. 5).

### Step S208

The output part 123 sends, to the user terminal 3, change confirmation information for confirming a request or non-request for a change of a planned receipt time with the user. FIG. 9 is an illustration of a display screen image G2 of the change confirmation information displayed on the user terminal 3. The display screen image G2 includes a message section 901, a “YES” button 902, and a “NO” button 903.

The message section 901 shows a message for confirming whether an ordered commodity is receivable from now with the user. Such receipt of the ordered commodity from now results in receipt of the ordered commodity before the planned receipt time, and thus means a change of the planned receipt time.

The “YES” button 902 is touched by the user when the user has a request for receiving the ordered commodity from now. The user terminal 3 sends the change request information to the server 1 in response to the touching of the “YES” button 902.

The “NO” button 903 is touched by the user when the user has a non-request for receiving the ordered commodity from now. The user terminal 3 sends information indicating the non-request for a change of the planned receipt time to the server 1 in response to the touching of the “NO” button 903.

### Step S209

The output part 123 determines whether the change request information is received. When the change request information is received (YES in step S209), the process proceeds to step S210.

When the change request information is not received (NO in step S209), that is, when information indicating a non-request for a change of the planned receipt time is received, the process proceeds to step S5 (FIG. 4).

The user may touch neither the “YES” button 902 nor the “NO” button 903. In this regard, the output part 123 may determine “NO” in step S209 when receiving neither the change request information nor information indicating a non-request for a change of the planned receipt time until a lapse of a predetermined time period.

Examples of the case of “NO” in step S209 include a case where a user enters the administrative region a predetermined number of period before the planned receipt time to take a rest in the administrative region.

### Step S210

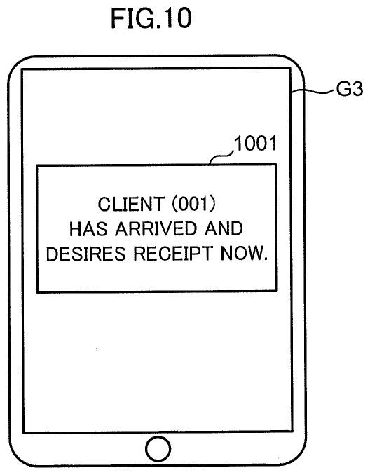

The output part 123 sends the receivable information and the parking location information determined in step S207 to the store terminal 4. FIG. 10 is an illustration of a display screen image G3 of the receivable information displayed on the store terminal 4. The display screen image G3 includes a message section 1001. The message section 1001 shows a message indicating that a customer (001) has arrived in the administrative region and an ordered commodity is receivable from now. The “customer (001)” indicates a user ID, and indicates, for example, the name of the user. A clerk having viewed the display screen image G3 picks up the ordered commodity of the user and delivers the ordered commodity to the user. The display screen image G3 may show a parking location of the user. This allows the clerk to deliver the ordered commodity to the parking location for the user. After a finish of step S210, the process proceeds to step S5 (FIG. 4).

### Step S211

This step is the same as step S105 (FIG. 5). After a finish of step S211, the process proceeds to step S5 (FIG. 4).

Conclusively, the second embodiment enables determination of a parking location which is suitable for a user after accurately specifying whether the user has a will to visit the store 301 even when a difference is larger than a given number.

### Third Embodiment

A third embodiment is aimed at estimating a selling section which a user is highly likely to visit from an order history of the user and determining a parking location on the basis of a location of the estimated selling section.

In the third embodiment, constituent elements which are the same as those in the first and second embodiments are given the same reference numerals and signs, and thus, description therefor will be omitted. Further, an overall configuration will be described with reference to FIG. 1 in the third embodiment.

Referring to FIG. 1, an acquisition part 121 further acquires, from a purchase history database 133, purchase history information about a user having entered.

FIG. 12 is a table showing an example of a data configuration of the purchase history database 133. The purchase history database 133 stores the purchase history information per user. In the purchase history database 133, one record is associated with one piece of purchase history information. The purchase history information indicates a commodity purchase history concerning purchase by a user per shopping in a store 301.

Specifically, the purchase history database 133 includes a commodity field, a classification field, and a purchase date and time field. The commodity field stores a commodity ID which is an identifier of a commodity purchased by the user. The classification field stores a classification code of the commodity purchased by the user. Examples of the classification code include beverage, a fruit and vegetable, a fresh food, a frozen food, and sweets. The purchase date and time indicates a date and time when the user purchased the commodity. For instance, the first row of the order history shows a purchase of a commodity “0001a” denoting beverage at 14:00 on Monday on November 1^{st}. The purchase history database 133 may store purchase history information about a commodity of the store 301 purchased online.

Referring to FIG. 1, a determination part 122 estimates a selling section which the user having entered is highly likely to visit in the store 301 on the basis of the purchase history information. The determination part 122 determines, as parking location information, location information about a parking location which is a distance equal to or shorter than a predetermined distance away from the estimated selling section.

In the embodiment, the selling section is, for example, at an arrangement location of the commodity in the store 301. However, this is just an example. For instance, a shopping mall may be provided with another store which is different from the store 301 in an administrative region thereof. In this case, the selling section may be a location of another store in the administrative region.

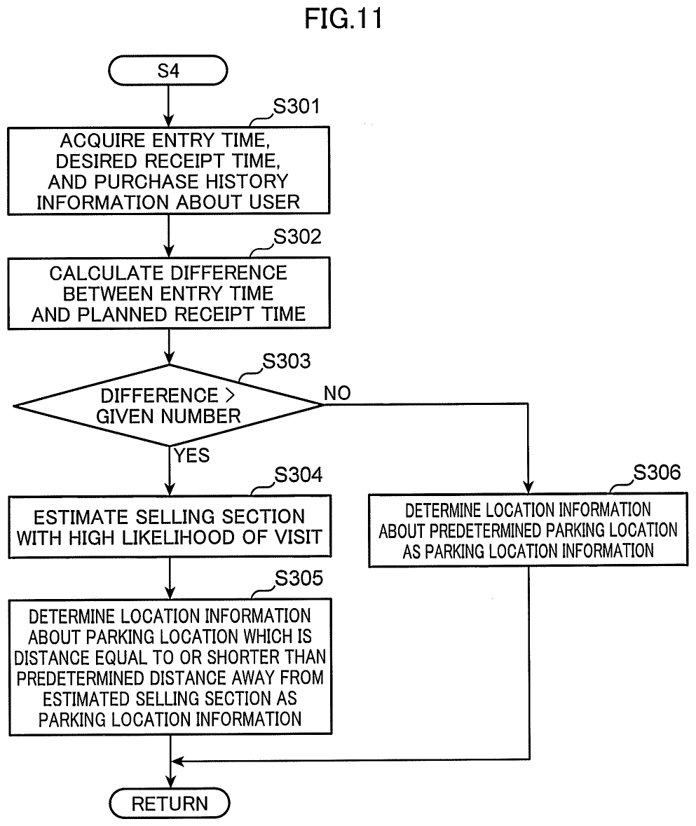

FIG. 11 is a flowchart showing an example of a process in the third embodiment. The third embodiment uses the main flowchart shown in FIG. 4 or FIG. 6. The flowchart in FIG. 11 shows details of step S4 in FIG. 4. Although the flowchart in FIG. 11 is adapted to step S4 in FIG. 4 here, the flowchart may be adapted to step S4 in FIG. 6.

Step S301 to step S303 are the same as steps S101 to S103 in FIG. 5, and thus, description therefor will be omitted.

### Step S304

The determination part 122 acquires, from the purchase history database 133, purchase history information about a user having entered, and estimates a selling section which the user having entered is highly likely to visit in the store 301 on the basis of the acquired purchase history information.

For instance, such a selling section is estimated on the basis of a day of week. With reference to FIG. 12, “today” on which the user entered is defined as Monday. In this case, the determination part 122 may specify purchase history information on the same day of week, i.e., each Monday, as today from the purchase history information about the user having entered, collect classification codes per classification for the specified purchase history information, and estimate a selling section of a commodity associated with a classification code having the largest total value as a selling section which the user is highly likely to visit. In the example in FIG. 12, the classification code having the largest total value on Mondays indicates the beverage, and thus, a beverage section is estimated as the selling section which the user is highly likely to visit.

For example, the selling section may be estimated on the basis of a timeframe. With reference to FIG. 12, the user has entered in a timeframe of one hour from 9 o'clock. In this example, the determination part 122 may specify, from the purchase history information about the user having entered, purchase history information in the same timeframe of one hour (from 9 o'clock) as the timeframe in which the user entered, collect classification codes per classification for the specified purchase history information, and estimate a selling section of a commodity belonging to a classification code having the largest total value as a selling section which the user is highly likely to visit. In the example in FIG. 12, the classification code having the largest total value in the timeframe of one hour from 9 o'clock is associated with the fruit and vegetable, and thus, a fruit and vegetable section is estimated as the selling section which the user is highly likely to visit. The timeframe is not limited to such an hourly basis, and may be a timeframe of a predetermined time period set to two or more, or another timeframe, such as a timeframe of morning, afternoon, or nighttime.

### Step S305

The determination part 122 determines, as parking location information, location information about a parking location which is a distance equal to or shorter than a predetermined distance away from the estimated selling section.

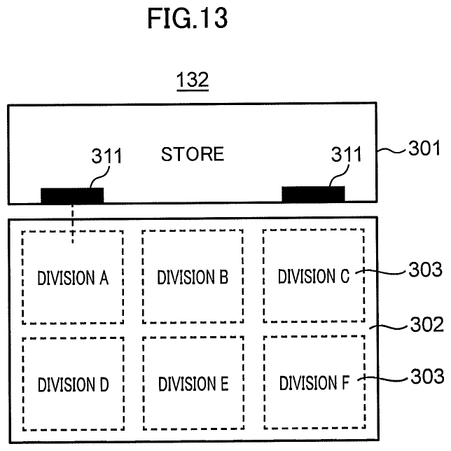

FIG. 13 is an illustration of parking information 132 in the third embodiment of the disclosure. A store 301 has two doorways 311. In this example, a left doorway 311 serves as a doorway 311 which is at a shortest distance from the location of the estimated selling section. The determination part 122 determines, as parking location information, location information about a division A defined in advance as a division 303 which is within a predetermined distance from the left doorway 311. For instance, the determination part 122 may define a coordinate of the center of the doorway 311 as a location of the doorway 311. A memory 13 stores a selling section database associating a plurality of classification codes with location information about respective selling sections related to the classification codes. The location information about each of the selling sections indicates a coordinate of the selling section in the store 301. Therefore, the determination part 122 may calculate a distance between a coordinate of a location of the estimated selling section and a coordinate of a location of each of the doorways 311 to specify a particular doorway 311 at the shortest distance from the estimated selling section.

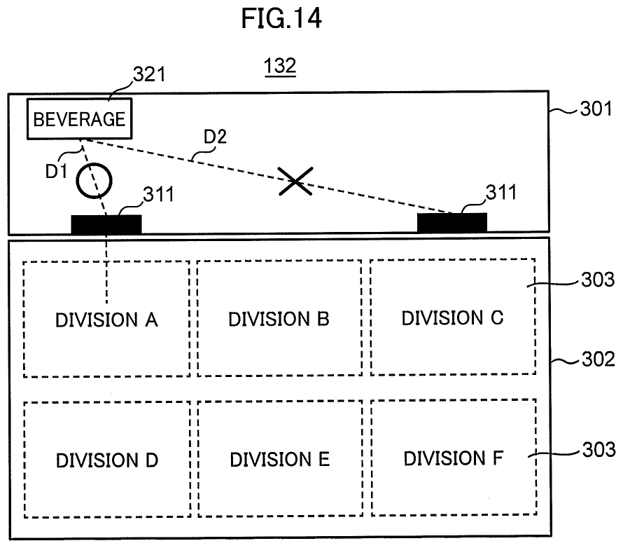

FIG. 14 is an illustration of details of the parking information 132 in the third embodiment. The parking information 132 indicates a mapped layout of the store 301. In this example, the estimated selling section is a beverage section 321. The determination part 122 calculates a distance D1 between the beverage section 321 and the left doorway 311 and a distance D2 between the beverage section 321 and a right doorway 311. The distance D1 is shorter than the distance D2, and thus, the determination part 122 specifies the left doorway 311, and determines the division A which is at the shortest distance from the specified doorway 311 as a parking location. For instance, the determination part 122 may define a coordinate of the center of a selling section as a location of the selling section.

### Step S306

This step is the same as step S105 (FIG. 5).

Conclusively, in the third embodiment, a parking location near a selling section which a user is highly likely to visit in an administrative region is determined, and thus, the third embodiment attains higher convenience for the user.

### Fourth Embodiment

A fourth embodiment is aimed at estimating another store which a user is highly likely to visit and determining a parking location. In the fourth embodiment, constituent elements which are the same as those in the first to the third embodiments are given the same reference numerals and signs, and thus, description therefor will be omitted. The fourth embodiment adopts the same diagram of an overall configuration as the diagram in FIG. 1 and the same flowchart as the flowchart in FIG. 11.

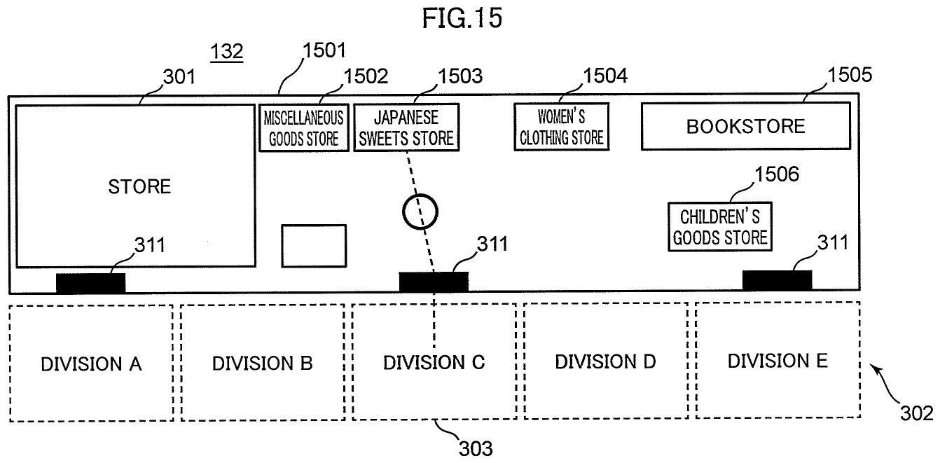

FIG. 15 is an illustration of an example of parking information 132 in the fourth embodiment. A shopping mall 1501 is located in an administrative region. The shopping mall 1501 includes a store 301 and other stores. Examples of the store 301 include a general supermarket. The store 301 offers a pickup service for delivering an ordered commodity purchased online by a user to a parking location. Examples of other stores include a miscellaneous goods store 1502, a Japanese sweets store 1503, a women's clothing store 1504, a bookstore 1505, and a children's goods store 1506. The parking information 132 includes a mapped layout of the store 301 and other stores in the shopping mall 1501 in addition to a mapped layout of a parking place 302. In the example in FIG. 15, the shopping mall 1501 has three doorways 311 of left, center, and right doorways.

In the embodiment, each of steps S304 and S305 in FIG. 11 will be described below.

A determination part 122 acquires, from a purchase history database 133, purchase history information about a user having entered, and estimates, on the basis of the acquired purchase history information, another store which the user is highly likely to visit. For instance, the determination part 122 specifies a classification record having the largest total value by using the way described above for step S304 from the purchase history information which is about purchase by the user in the store 301 and is stored in the purchase history database 133. Subsequently, the determination part 122 estimates another store selling a commodity having the specified classification code as another store which the user is highly likely to visit.

In the example in FIG. 15, the classification code having the largest total value indicates sweets, and thus, the Japanese sweets store 1503 is estimated as another store which the user is highly likely to visit. It is seen from these perspectives that the center doorway 311 which is at the shortest distance from the Japanese sweets store 1503 is specified, and a division C defined in advance as a parking location which is at the shortest distance from the specified doorway 311 is determined as a parking location.

Conclusively, the fourth embodiment enables determination of a parking location which is highly convenient for a user who plans to visit another store.

### First Modification of the Fourth Embodiment

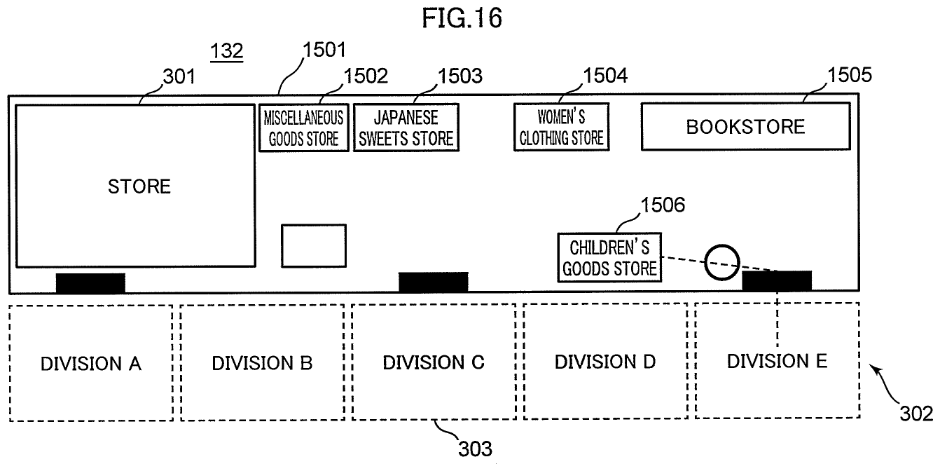

FIG. 16 is an illustration of an example of parking information 132 in a modification of the fourth embodiment. A layout of a shopping mall 1501 and a parking place 302 in FIG. 16 is the same as the layout in FIG. 15.

In the first modification, a determination part 122 acquires attribute information about a user from a user information database 135, and estimates another store which the user is highly likely to visit on the basis of the acquired attribute information. Referring to FIG. 16, for instance, in a case where a user having entered is a woman having a child, the determination part 122 specifies a children's goods store 1506 as another store which the user is highly likely to visit. The determination part 122 then specifies a right doorway 311 which is closest to the children's goods store 1506, and determines, as a parking location, a division E defined in advance as a parking location which is at a shortest distance from the specified doorway 311.

For instance, in a case where an occupation of a user having entered indicates a student, the determination part 122 may estimate a bookstore 1505 as another store which the user is highly likely to visit.

The determination part 122 may estimate another store by using a rule created in advance for estimating another store from the attribute information.

### Second Modification of the Fourth Embodiment

In a second modification of the fourth embodiment, a purchase history database 133 stores purchase history information for another store in addition to purchase history information for a store 301. The purchase history information for another store includes purchase history information about an ordered commodity having been ordered online to another store in addition to purchase history information about a commodity actually purchased in another store. Another store is defined to offer a pickup service for receiving an order online and delivering an ordered commodity to a parking location.

A determination part 122 may specify a store which the user has visited most frequently from purchase history information about the user in other stores, and estimate the specified store as another store which the user is highly likely to visit.

For instance, in response to an entry of a user having the most frequent commodity purchases in a bookstore 1505, the determination part 122 may specify the bookstore 1505 as another store which the user is highly likely to visit.

This disclosure is useful for an efficient delivery of a commodity in a large-scale store.

1. An information processing method for providing information about delivery of commodities at a store, the information processing method comprising:
by a computer,
acquiring entry information indicating an entry of a user into an administrative region of the store and including a user ID, an entry time when the user entered, and a planned receipt time associated with the user ID for receiving a commodity;
determining, when a difference between the entry time and the planned receipt time is larger than a given number, location information about a parking location which is a distance equal to or shorter than a predetermined distance away from the store as parking location information on the basis of parking information which is held in a memory and includes location information about parking locations in a parking place in the administrative region; and
outputting the parking location information.

2. The information processing method according to claim 1, wherein,
in the determining, when the difference is smaller than the given number, location information about a predetermined parking location is determined as the parking location information on the basis of the parking information.

3. The information processing method according to claim 1, wherein the parking location information which is determined when the difference is larger than the given number indicates a parking location which is a distance equal to or shorter than the predetermined distance away from a doorway of the store.

4. The information processing method according to claim 1, wherein,
in the outputting, confirmation information for confirming a visit or non-visit to the store is output when the difference is larger than the given number, and the location information about the parking location which is the distance equal to or shorter than the predetermined distance away from the store is output as the parking location information on receipt of information indicating the visit to the store.

5. The information processing method according to claim 1, wherein,
in the outputting, confirmation information for confirming a visit or non-visit to the store is output when the difference is larger than the given number, and change confirmation information for confirming a request or non-request for a change of the planned receipt time is output on receipt of information indicating the non-visit to the store.

6. The information processing method according to claim 5, wherein,
in the outputting, receivable information indicating that the commodity is receivable is output on receipt of change request information indicating the request for the change of the planned receipt time.

7. The information processing method according to claim 1, wherein,
in the acquiring, purchase history information concerning past purchase by the user including at least a purchase date and time and a purchased commodity is acquired, and,
in the determining,
a selling section which the user is highly likely to visit in the store is estimated on the basis of the purchase history information, and
location information about a parking location which is a distance equal to or shorter than the predetermined distance away from the estimated selling section is determined as the parking location information.

8. The information processing method according to claim 7, wherein the selling section is at an arrangement location of the commodity in the store or a location of another store which is in the administrative region.

9. The information processing method according to claim 1, wherein the parking location information is output to a user terminal carried by the user and a store terminal carried by a clerk of the store.

10. The information processing method according to claim 1, wherein the memory holds a user database associating the user ID and a vehicle number with each other, and,
in the acquiring, a vehicle image is acquired by photographing a vehicle in the entry into the administrative region by the camera, the vehicle number is specified from the vehicle image, and the entry information is determined to be acquired when the user ID associated with the specified vehicle number is specified from the user database.

11. An information processing device that provides information about delivery of commodities at a store, the information processing device comprising:
an acquisition part that acquires entry information indicating an entry of a user into an administrative region of the store and including a user ID, an entry time when the user entered, and a planned receipt time associated with the user ID for receiving a commodity;
a determination part that determines, when a difference between the entry time and the planned receipt time is larger than a given number, location information about a parking location which is a distance equal to or shorter than a predetermined distance away from the store as parking location information on the basis of parking information which is held in a memory and includes location information about parking locations in a parking place in the administrative region; and
an output part that outputs the parking location information.

12. A non-transitory computer readable recording medium storing an information processing program for providing information about delivery of commodities at a store, the program comprising:
causing a computer to execute:
acquiring entry information indicating an entry of a user into an administrative region of the store and including a user ID, an entry time when the user entered, and a planned receipt time associated with the user ID for receiving a commodity;
determining, when a difference between the entry time and the planned receipt time is larger than a given number, location information about a parking location which is a distance equal to or shorter than a predetermined distance away from the store as parking location information on the basis of parking information which is held in a memory and includes location information about parking locations in a parking place in the administrative region; and
outputting the parking location information.
